(19) United States
(12) Patent Application Publication
(10) Pub. No.: US 2013/0335541 A1
(43) Pub. Date: Dec. 19, 2013

(54) METHOD AND MOBILE DEVICE FOR VIDEO OR PICTURE SIGNING OF TRANSACTIONS, TASKS/DUTIES, SERVICES, OR DELIVERIES

(71) Applicant: Michael Hernandez, Carlsbad, NM (US)

(72) Inventor: Michael Hernandez, Carlsbad, NM (US)

(21) Appl. No.: 13/527,468

(22) Filed: Jun. 19, 2012

(51) Int. Cl. H04N 7/18

(52) U.S. Cl. 348/61; 348/E07.085

(57) ABSTRACT

A method and system for digitally signing utilizes a mobile device with an image capture device to electronically record the signing. A signer may accept, reject, or partially accept/reject a transaction or contract. The signer selects which action to take, and one or more images and possibly audio are captured of the signer as well potentially as other information concerning the signing. When complete, the information about the transaction is saved and may be transmitted to a server. A video signing captures a video stream of images, including potentially audio. A picture signing captures one or more photos.

### BACKGROUND OF THE INVENTION

1. Field of the Invention

The present invention relates to a mobile device and, more specifically, to a method and system that provides for video or picture signing for transactions, service, task/duties, or deliveries.

2. The Prior Art

Package delivery by companies, such as FedEx and UPS has been automated, with packages being tracked as they proceed across the country. Currently, these companies scan a bar code affixed to packages whenever a package enters or leaves any of their facilities, and is scanned at the destination. This information is routinely uploaded to a database that is made available to customers so that they can see where their packages are, as they progress from shipper to receiver.

Some of the scanning is automated, and some of the bar code scanners are electronically connected to the database systems, and other scanners upload their data on a periodic basis. For example, some scanners are uploaded when they are docked for their daily recharging.

One problem with the hand held scanners is that their accuracy is dependent upon the person using them. Bar codes can be removed or replaced on packages. And, in the case of most deliveries, the accuracy of the delivery is highly dependent upon the honesty and conscientiousness of the delivery person. Similarly, when the delivery person has someone sign for delivery of a package, it is quite possible that that person is not actually the person who was supposed to take delivery of the package. After the person signs, either the delivery person's handheld device or a paper receipt, all that the delivery company has is that signature, which may be forged.

### BRIEF SUMMARY OF THE INVENTION

This patent discloses and claims a useful, novel, and unobvious invention for a mobile device providing for video or picture signing in the mobile device field.

A method and system for digitally signing utilizes a mobile device with an image capture device to electronically record the signing utilizing a picture or video as the signature. A signer may accept/authorize/submit, reject, or partially accept-authorize-submit/reject a transaction, contract, document, shipment, field ticket, etc. The signer selects which action to take, and one or more images, possibly face recognition and possibly audio are captured of the signer as well potentially as other information concerning the signing. When complete, the information about the transaction is saved and may be transmitted to a server. A video signing captures a video stream of images, including potentially audio. A picture signing captures one or more photos. Both video and picture signing may utilize face recognition.

### BRIEF DESCRIPTION OF THE DRAWINGS

FIG. 1 is a block diagram showing elements of one embodiment of the present invention.

FIG. 2 is a flowchart of a delivery sequence, in accordance with one embodiment of the present invention.

FIG. 3 is a flowchart illustrating acceptance of an agreement, transaction, delivery, etc. in accordance with one embodiment of the present invention.

FIG. 4 is a flowchart illustrating rejection of an agreement, transaction, delivery, etc., in accordance with one embodiment of the present invention.

FIG. 5 is a flowchart illustrating partial rejection, partial acceptance, or modification of an agreement, transaction, delivery, etc., in accordance with one embodiment of the present invention.

FIG. 6 is a diagram illustrating an exemplary normal view screen for a mobile device, in accordance with one embodiment of the present invention.

FIG. 7 is a diagram illustrating an exemplary “Signature Options” screen for a mobile device, in accordance with one embodiment of the present invention.

FIG. 8 is diagram illustrating an exemplary “Video Signature” screen for a mobile device, in accordance with one embodiment of the present invention.

FIG. 9 is diagram illustrating an exemplary “Picture Signature” screen for a mobile device, in accordance with one embodiment of the present invention.

FIG. 10 is a flowchart of a monetary transaction sequence, in accordance with one embodiment of the present invention.

FIG. 11 is a flowchart of a real estate transaction sequence, in accordance with one embodiment of the present invention.

FIG. 12 is a flowchart of an employee duty or task completion sequence, in accordance with one embodiment of the present invention.

### DETAILED DESCRIPTION

The present invention includes a method and apparatus for using a video signature/sign and/or picture signature/sign as a way to obtain signatures on mobile devices for any purpose requiring signature or approval. The present invention utilizes either a video or a photo as the digital signature. In addition to the video or photograph, may utilize face recognition, the date and time of the signing, and the location of the signing, through, for example, the use of GPS, may also be recorded and ultimately uploaded to a server, along with a copy of the video or picture signature. Indeed, since the GPS system in use provides highly accurate time values, this provides a way to determine down to the second when the transaction, agreement, shipped goods, task/duties, etc. was signed, and within a very small area of where it was signed. When face recognition is utilized it will provide another form of verification on the person that is digital signing.

The digital video or picture, face recognition verification, location, date/time, and digitized signature can be attached to any document of any type requiring a signature, such as an invoice, ticket, order, delivery verification, work performed in the field, etc. The invention also provides for rejection of an order, in full or in part, and when rejected, the video/photo capabilities may be utilized to record the status of what is being rejected. Thus, if ten barrels are delivered, and one of them is damaged, the recipient can reject that barrel, and show how it was non-conforming.

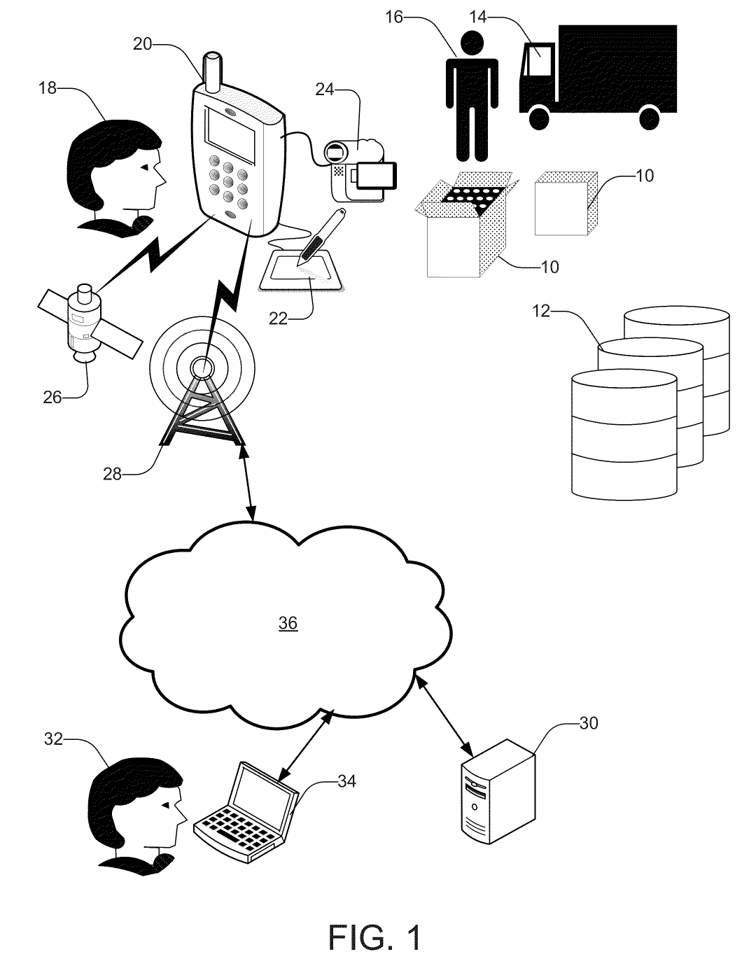

FIG. 1 is a block diagram showing elements of one embodiment of the present invention. In this diagram, boxes 10 and barrels drums 12 are delivered by truck 14. A delivery person 16 delivers these items to a recipient or signer 18. A handheld or mobile device 20 is utilized to record the transaction or delivery. In this FIG., the mobile device 20 is shown connected to a signature pad 22 and a video camera 24. This is exemplary, and it should be understood that this functionality will preferably be included in a single device. Also shown is a GPS satellite 26 for providing accurate date/time and location information to the mobile device 20. The recipient or signer 18 may sign on the signature pad 22, and an audio recording may be attached to the signature. Instead of a written signature a video camera 24 or a still camera (not shown) may be utilized as the digital signature or combined with the signature on the signature pad 22.

The information from the mobile device 20, including possibly the digitized signature which may be one or a combination of signature, video or photo of the signer, may be uploaded through a wireless link 28 and stored in a database on a server 30. It should be understood that upload or communication (not shown) may utilize connection by infrared sensor, Wi-Fi, cellular tower, blue tooth, or other technology between recipient deice and signer device. The shipper or other party or person 32 may view the uploaded information on his computer 34, connected to the server 30 utilizing a network 36, such as the Internet.

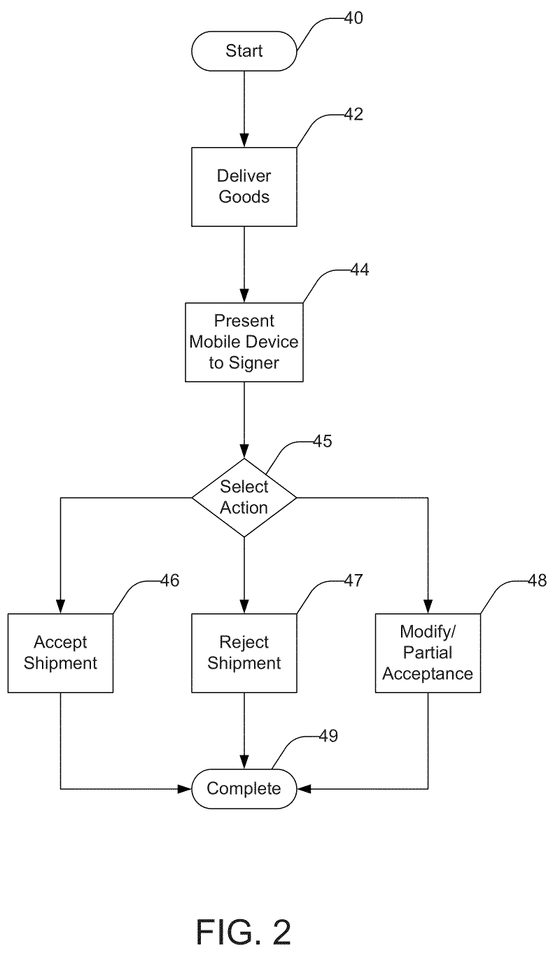

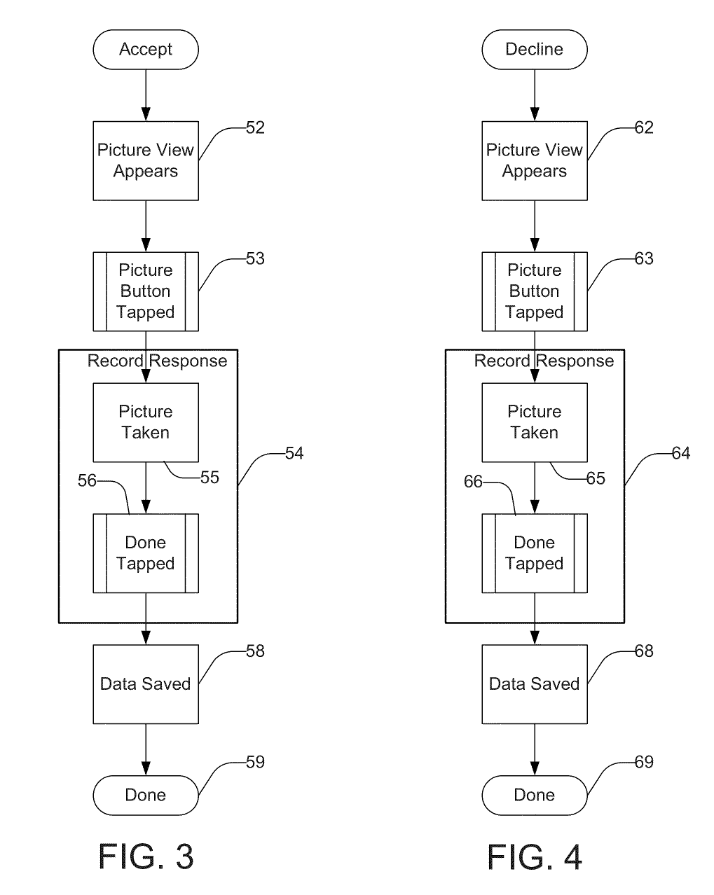

FIG. 2 is a flowchart of a delivery sequence 40, in accordance with one embodiment of the present invention. When goods are delivered or an agreement/document or transaction is presented to the signer 18, step 42, the mobile device 20 is presented to the signer 18, step 44. He selects which action to take, step 45. He may elect to accept the shipment, agreement/document, transaction, etc. at step 46, reject the shipment, agreement/document, transaction, etc., at step 47, or modify or partially accept the shipment, agreement/document, transaction, etc., at step 48. In some embodiments, a partial acceptance at step 48 may include having the signer select which shipment/agreement/document/etc signer to accept. After completing the acceptance, step 46, rejection, step 47, or partial acceptance (including any selection of shipment, agreement or document to accept), step 48, the delivery or acceptance/rejection/acceptance with changes sequence is complete, step 49 and will continue to the video signature or picture signature shown in FIGS. 3, 4, and 5.

FIG. 3 is a flowchart illustrating acceptance of an agreement, transaction, delivery, etc. in accordance with one embodiment of the present invention. The video or still camera 24 is turned on, and a real time picture/video appears on mobile device 20 display, step 52. Face recognition process the signers face, and states that signer is verified or signer not verified by face recognition. A picture button is tapped or clicked or voice command is given, step 53, and along with the real time picture/video text prompts will also be displayed instruction the signer of what information to verbally speak during the recording video/audio, the response is recorded, step 54. A video or photo is taken which is the digital signature of the signer, step 55. When this is complete, a Done button is tapped or clicked or voice command is given, step 56. The data is saved, step 58, and is transmitted to a server 30 in one embodiment of the present invention. The acceptance sequence is now complete, step 59.

When the signer 18 taps, or clicks, or voice commands an “Approved” button, device 20 will be checked for video capturing capabilities and if such capabilities exist video signature will begin. If device 20 has no video capturing capabilities a check for photo capturing capabilities will be performed and if photo capturing capabilities exist, photo signature will be performed. When device 20 has no video capturing capabilities or photo capturing capabilities, the signer will be prompted to sign the device screen along with audio capturing. It should be understood that the video capturing, picture capturing, and/or signature capture functionality may include audio capturing. For this example, it is assumed that video capturing capabilities were detected on mobile device 20. A video view will appear depicting live image/footage of signer in one embodiment of the present invention, that allows a video to be taken by tapping, clicking, or voice commanding a “Record” button. Once the “Record” Button is tapped, clicked, or voice commanded, the device 20 will begin recording with the signer being able to view recording in real time on device display, while the signer 18 follows prompts, which in one embodiment of the present invention are text prompts. It should be understood that prompts may be text prompts, audio prompts, or text and audio prompts combined. For example, the signer 18 may be asked to state his or her full name, the work order number being approved, a description of the job being approved, or whatever other information may be required by a specific application. When the signer 18 is done, a “Done” button may be tapped, clicked, or voice commanded. The data is saved, and the display returns to an initial view or menu. If the person signing decides not to video sign, a “Cancel” button can be tapped, clicked, or voice commanded to return to an initial view or menu. For the following example, it is assumed that video capturing capabilities were not detected on mobile device 20, but picture capturing capabilities were detected. In that situation, a picture view will appear depicting live image/footage of signer in one embodiment of the present invention, that allows a photo to be taken by tapping, clicking, or a voice commanding a “Take Picture” button. Once the Take Picture button is tapped, clicked, or voice commanded, the device 20 will then capture picture with signer being able to view captured pictures in real time on the device display, while the signer 18 follows prompts, which in one embodiment of the present invention are text prompts. It should be understood that prompts may be text prompts, audio prompts, or text and audio prompts combined. For example, the signer 18 may be asked to state or enter his or her full name, the work order number being approved, a description of the job being approved, or whatever other information may be required by a specific application. It should be understood that prompts may require an audio response or data entry using mobile device 20 keyboard or a combination of both audio response and data entry. When the signer 18 is done, a “Done” button may be tapped, clicked, or voice commanded. The data is saved, and the display returns to an initial view or menu. If the person signing decides not to photo sign, a “Cancel” button can be tapped or a voice command given or clicked to return to an initial view or menu.

FIG. 4 is a flowchart illustrating rejection of an agreement, transaction, delivery, etc., in accordance with one embodiment of the present invention. The video or still camera 24 is turned on, and a picture appears on the mobile device 20 display, step 62. A picture button is tapped, clicked, or voice commanded, step 63, and the response is recorded, step 64. A video or photo is taken, step 65, as the signer 18 signs the signature pad 22. When this is complete, a “Done” button may be tapped, clicked, or voice commanded, step 66. The data is saved, step 68, and is transmitted to a server 30 in one embodiment of the present invention. The rejection sequence is now complete, step 69.

A signer 18 can tap, click, or voice command a “Decline” button. In response, device 20 will be checked for video capturing capabilities and if such capabilities exist in device 20, video signature will begin. However, if device 20 has no video capturing capabilities, a check for photo capturing capabilities will be performed, and if photo capturing capabilities exist, photo signature will be performed. When device 20 has neither video capturing capabilities nor photo capturing capabilities, the signer will be prompted to sign the device screen along with audio capturing. It should be understood that the video capturing, picture capturing, and/or signature capture functionality may include audio capturing. For this example, it is assumed that video capturing capabilities was detected on mobile device 20. In this case, a video view may appear depicting live image/footage of signer, allowing for a video or photo be taken by tapping, clicking, or voice commanding a “Record” button. Once the “Record” button has been tapped, or clicked, or voice commanded, the device will begin recording while the signer is able to view recording in real time on device 20 display while the signer follows prompts, as described above. When a “Done” button is tapped, clicked, or voice commanded, the data can be saved and a return is made to the initial view on the mobile device. If the signer 18 decides not to video sign, a “Cancel” button may be tapped, clicked, or voice commanded to abort the video signing and to return to the initial view or menu.

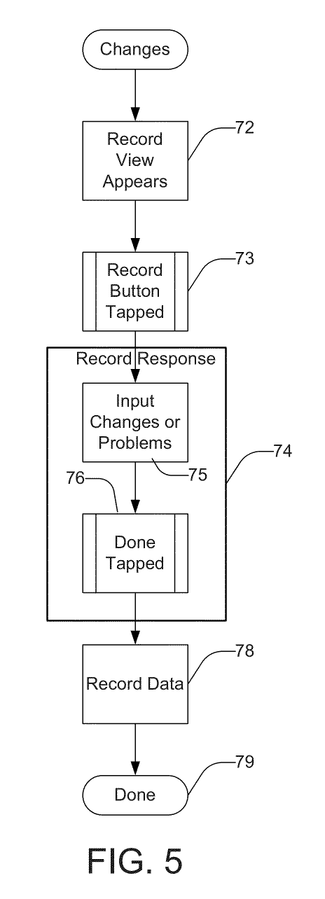

FIG. 5 is a flowchart illustrating partial rejection, partial acceptance, or modification of an agreement, transaction, delivery, etc., in accordance with one embodiment of the present invention. The video or still camera 24 is turned on, and a picture appears on mobile device 20 display, step 72. A “Picture” button is tapped, clicked, or voice commanded, step 73, and the response is recorded, step 74. A video or photo is taken, step 75, signer will describe partial acceptance or partial rejection. When this is complete, a “Done” button may be tapped, clicked, or voice commanded, step 76. The data is saved, step 78, and is transmitted to a server 30 in one embodiment of the present invention. The partial rejection/partial acceptance sequence is now complete, step 79.

A signer 18 can tap a “Decline/Changes” or “Accept/Changes” button. In response, a video view may appear, allowing for a video or photo be taken by tapping, clicking, or voice commanding a “Record” button. Once the “Record” button has been tapped, clicked, or voice commanded, the device will begin recording while signer describe partial acceptance or partial rejection, following prompts, as described above. When a “Done” button is tapped, clicked or voice commanded, the data can be saved and a return is made to the initial view on the mobile device. If the person decides not to video or picture sign, a “Cancel” button may be tapped, clicked, or voice commanded to abort the video signing and to return to the initial view or menu.

One of the advantages of this invention is that a person video or picture signing may make changes, reservations, partially accept, partially reject, etc. a job or delivery. Thus, five barrels may be shipped in an order, but one of them is damaged. The person signing may point this out, showing the damaged goods in the video or a photo. In the case of making changes to a work order, the signer 18 may state the changes in the video when signing, or may enter the terms or changes into text boxes and the like provided by the handheld device 20.

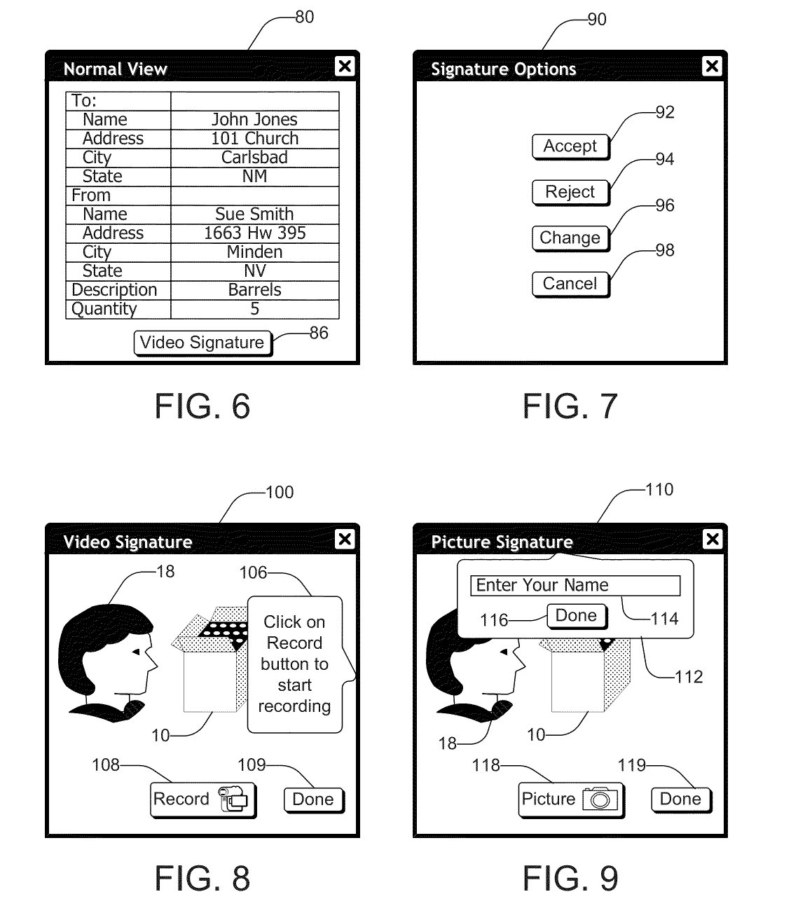

FIG. 6 is a diagram illustrating an exemplary normal view screen for a mobile device 20, in accordance with one embodiment of the present invention. In this example, an exemplary default normal view screen 80 is shown. It shows the delivery information for some goods, including the shipper, recipient, and a description of the goods. At the bottom of the screen is a “Video Signature” button 86.

FIG. 7 is a diagram illustrating an exemplary “Signature Options” screen 90 for a mobile device 20, in accordance with one embodiment of the present invention. The “Signature Options” screen 90 may be launched by clicking, tapping, or voice commanding the “Video Signature” button 86 shown in FIG. 5. The exemplary screen shows four buttons: “Accept” 92, “Reject” 94, “Change” 96, and “Cancel” 98. Clicking, tapping, or voice commanding the “Accept” button 92 launches the Acceptance sequence shown in FIG. 3. Clicking, tapping, or voice commanding the “Reject” button 94 launches the Rejection sequence shown in FIG. 4. Clicking, tapping, or voice commanding the “Change” button 96 launches the Modify sequence shown in FIG. 5. Clicking, tapping, or voice commanding the “Cancel” button 98 returns a user to the Normal View screen shown in FIG. 6. It should be understood that these buttons and configuration are exemplary, and others are also within the scope of the present invention. For example, some of the possible options are: Approve; Authorize; Accept; Accept with Changes; Complete; Counter; Decline; Decline with Changes; Partial Acceptance; Partial Rejection; Reject; etc.

FIG. 8 is diagram illustrating an exemplary “Video Signature” screen 100 for a mobile device 20, in accordance with one embodiment of the present invention. It may be launched by a signer 18 clicking, tapping, or voice commanding the Accept 92, Reject 94, or Change 96 buttons shown in FIG. 7. In this screen may be shown the signer 18. Also, goods 10, 12 being delivered may also be shown. In this example, the boxes from FIG. 1 are shown. One of the boxes is opened to display its contents. There may also be shown instructions or a prompt 106. In this example, the prompt instructs the person to “Click on Record button to start recording”. This is exemplary, and other wording and other prompts are also within the scope of the present invention. Also, the prompt 106 may be in different forms. For example, it may be a pop-up, screen tip, or balloon. A “Record” button 108 may be shown. When this button is clicked, tapped, or voice commanded the video recording of the signature process is initiated. One or more images of the person signing may be recorded, as well as anything they say, including modifications to an agreement, reservations, etc. Goods being delivered may be included in the recording, allowing the signer 18 to point out any discrepancies with the order. There is also a “Done” button 109, that when tapped, clicked, or voice commanded, may cause the signature process to complete, and the data recorded to be saved.

FIG. 9 is diagram illustrating an exemplary “Picture Signature” screen 110 for a mobile device 20, in accordance with one embodiment of the present invention. It may be launched by a signer 18 clicking, tapping. or voice commanding the Accept 92, Reject 94, or Change 96 buttons shown in FIG. 7. In this screen may be shown the signer 18 or another person who will provide a picture signature. Thus, a photo of the person signing may be obtained and saved. Goods 10, 12 being delivered may also be shown. In this example, the boxes from FIG. 1 are shown. One of the boxes is opened to display its contents. At the top of the screen is a prompt box 112 containing a text box 114 for the person utilizing the Picture Signature to enter his or her name. There is also a “Done” button 116 for that person to click, tap, or voice command when he or she completes entering their name. A “Picture” button 118 may be shown. When this button is clicked, tapped, or voice commanded, a picture of the signer 18 is taken. This differs from the Video Signature in that a still photo is taken instead of a video. In one embodiment, the person utilizing the Picture Signature will first click the Picture button 118, which will cause a picture to be taken. Then, he or she will be prompted to enter their name. Other alternatives are also within the scope of the present invention, such as reversing the order of these steps. Furthermore, other information may be requested of the signer. There is also a “Done” button 119, that when tapped, clicked, or voice commanded may cause the signature process to complete, and the data recorded to be saved.

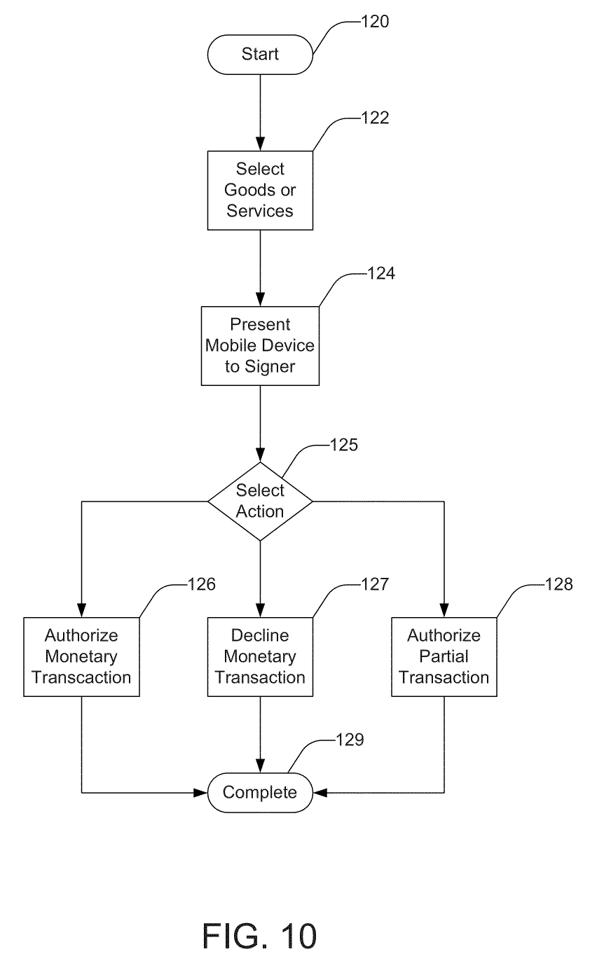

FIG. 10 is a flowchart of a monetary transaction sequence 120, in accordance with one embodiment of the present invention. A merchant or signer can select/enter goods and/or services, step 122. The mobile device 20 may then be presented to the signer 18, step 124. He selects which action to take, step 125. He may elect to authorize the monetary transaction, step 126, decline the monetary transaction, step 127, or authorize a partial monetary transaction, step 128. After completing the authorization, step 126, rejection, step 127, or partial acceptance, step 128, the monetary transaction sequence is complete, step 129 and will continue to the video signature or picture signature shown in FIGS. 3, 4, and 5.

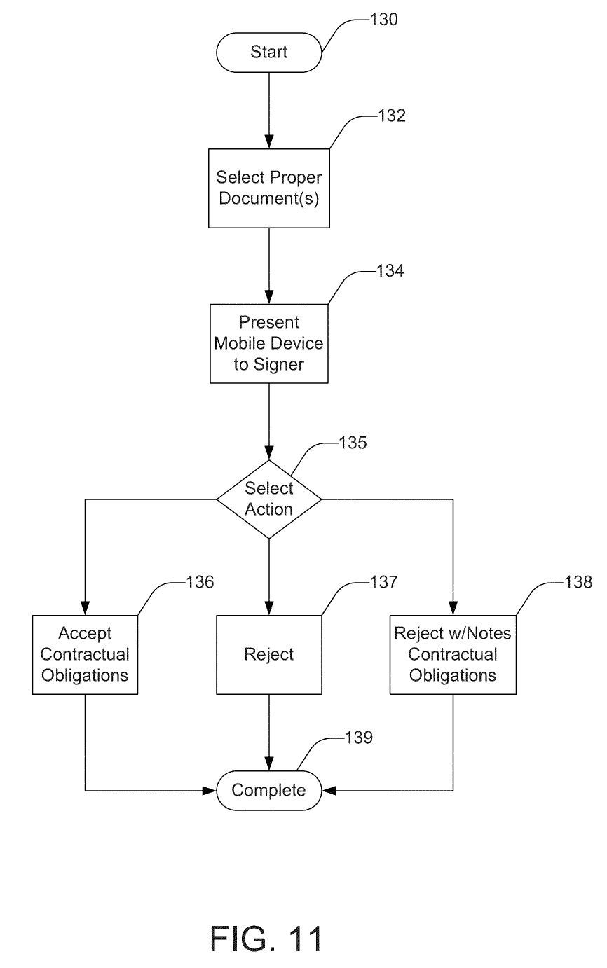

FIG. 11 is a flowchart of a real estate transaction sequence 130, in accordance with one embodiment of the present invention. A real estate broker, agent, or employee can select the proper documents, step 132. The mobile device 20 may then be presented to the signer 18, step 134. He selects which action to take, step 135. He may elect to accept the contract terms and obligations, step 136, decline the contract terms and obligations, step 137, or reject the contractual obligations with notes, step 138. After completing the acceptance, step 136, rejection, step 137, or partial rejection, step 138, the real estate documents sequence is complete, step 139 and will continue to the video signature or picture signature shown in FIGS. 3, 4, and 5.

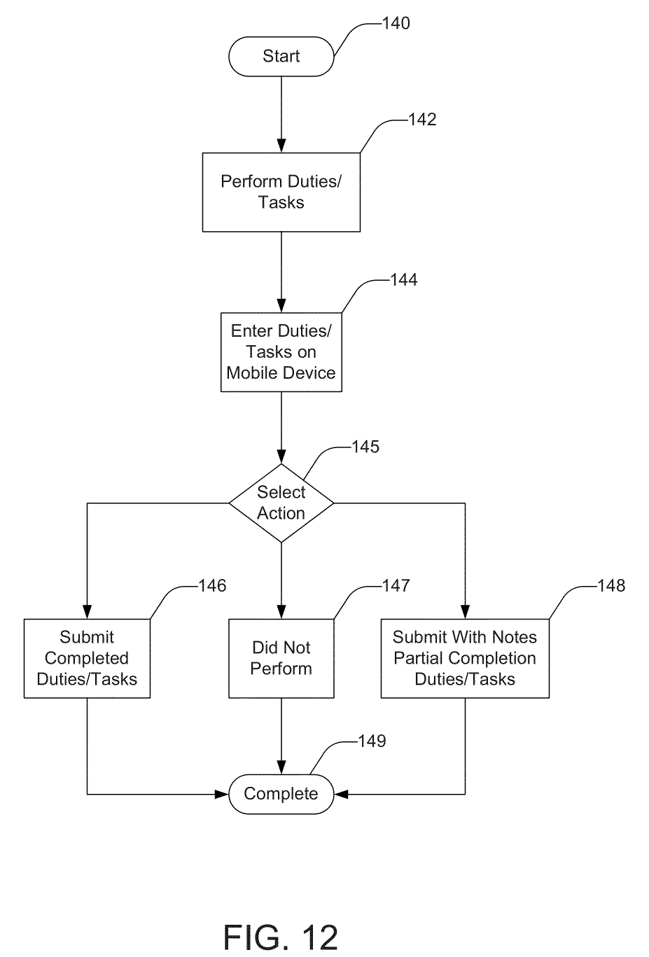

FIG. 12 is a flowchart of an employee duty or task completion sequence 140, in accordance with one embodiment of the present invention. The duties or tasks can be performed, step 142. The mobile device 20 may then be presented to the signer 18, step 144, who may be the employee. He selects which action to take, step 145. He may elect to submit completed duties or tasks, step 146, indicate that he did not perform the duties or tasks, step 147, or submit partial completion with notes, step 148. After completing the completion submission, step 146, non-performance, step 147, or partial completion, step 148, the recording of the duty or task completion sequence is complete, step 149 and will continue to the video signature or picture signature shown in FIGS. 3, 4, and 5.

It should be understood that the screens shown in FIGS. 6-12 are exemplary, and other screens and arrangements are also within the scope of the present invention. Windows may be utilized, including pop-up windows. Also, window/screen command buttons are shown in these FIGs. This implies the use of some sort of pointing device, such as a touch screen, mouse, stylus, electronic pen, etc. Other technologies and implementations are also within the scope of the present invention. For example, some of the button functionality may be implemented through swipes. Another alternative is that some of the buttons may be implemented as physical buttons on a dedicated handheld or mobile device 20.

Those skilled in the art will recognize that modifications and variations can be made without departing from the spirit of the invention. Therefore, it is intended that this invention encompass all such variations and modifications as fall within the scope of the appended claims.

What is claimed is:

1. A method of electronically signing for a transaction utilizing a mobile device having an image capture device, comprising:
utilizing the mobile device by a signer;
providing the signer with a list of signing options;
accepting a selection of a signing option from the list of signing options from the signer;
electronically recording at least one image of the signer utilizing the image capture device; and
storing information about the transaction including the at least one image recorded.

2. The method in claim 1 which further comprises:
accepting from the signer additional information concerning the transaction.

3. The method in claim 2 wherein the additional information includes additional or amended terms.

4. The method in claim 2 wherein the additional information includes partial delivery information.

5. The method in claim 1 wherein the information about the transaction stored includes a date, time, and spatial location of the mobile device when the signing was completed.

6. The method in claim 1 wherein the image capture device is a video recorder and a series of frames of video are captured and stored in a video signing.

7. The method in claim 1 wherein the image capture device is a camera, and at least one electronic photos are captured and stored in a picture signing.

8. The method in claim 1 which further comprises:
transmitting the saved transaction information to a server.

9. The method in claim 8 wherein:
the transaction is the delivery of goods;
the digital signing is integrated into a delivery history for the goods being delivered.

10. The method in claim 1 wherein the mobile device integrally contains:
the image capture device;
a touch-screen for displaying options and accepting selections by the signer; and
a GPS unit for determining date, time, and location.

11. A mobile device for accepting electronic signing of a transaction comprising:
an image capture device capable of recording at least one electronic image;
a display device for providing information to a signer;
an input device for accepting selections from and initiating functions by the signer; and
control means for:
providing a list of signing options on the display device to the signer;
accepting from the signer a selection of a signing option from the list of signing options;
electronically recording at least one image of the signer utilizing the image capture device; and
storing information about the transaction including the at least one image recorded.
